(19) United States
(12) Patent Application Publication
(10) Pub. No.: US 2008/0011556 A1
(43) Pub. Date: Jan. 17, 2008

(54) Elevator door operator and interlock arrangement

(76) Inventors: Timothy P. Galante, West Hartford, CT (US); Richard Kulak, Bristol, CT (US); Harold Terry, Avon, CT (US); Jacobus Benjamin Legez, De Kwakel (NL)

Correspondence Address: CARLSON GASKEY & OLDS, 400 W MAPLE STE 350, BIRMINGHAM, MI, 48009, US

(21) Appl. No.: 10/577,871

(22) PCT Filed: Nov. 4, 2003
(86) PCT No.: PCT/US03/34911

§ 371 Date: Apr. 28, 2006

(51) Int. Cl. B66B 1/02

(52) U.S. Cl. 187/309

(57) ABSTRACT

An elevator door moving arrangement includes a door mover (40) and an interlock device (42) supported near a lower edge (44) of cabin doors (26). The strategic position of the door mover (40) and the interlock device (42) minimizes the distance between the sill member (34, 78) and the operative components for moving the doors. In one example, the entire door mover assembly and the interlock are located beneath a sill member (34), which is beneath the bottom edge of the doors (26).

### FIELD OF THE INVENTION

This invention generally relates to elevator door systems. More particularly, this invention relates to a unique arrangement of an elevator door operator and interlock.

### DESCRIPTION OF THE RELATED ART

Modern elevator systems include a car that moves through a hoistway between landings in a building. The car includes a cabin portion within which passengers or cargo are transported between different levels in the building. There are cabin doors that open to allow egress to the cabin interior when the car is appropriately positioned relative to a selected landing. There also are hoistway doors at the hoistway entrance of the corresponding landing.

Typical arrangements include a door operator or mover mechanism located at the top of the cabin. A door interlock that provides for simultaneous movement of the cabin doors and the hoistway entrance doors typically is also mounted near the top of the cabin and in some instances above the doors. While such arrangements have proven effective and useful, they are not without shortcomings and drawbacks.

One shortcoming of the conventional arrangement is that the overhead clearance above the cabin is reduced by the presence of the door operator and interlock components. Another shortcoming is that the distance between the alignment points of the interlock (near to top) and the sill (near the bottom of the doors) introduces additional complexities during elevator installation. Relatively complex or cumbersome alignments and adjustments required to achieve acceptable operation of the interlock and smooth door movement stem from the distance between the sill and the interaction point of the interlock between the car doors and the hoistway entrance doors.

There is a need for an improved arrangement that simplifies the installation procedure and improves the tolerance issues presented to achieve appropriate door alignment. This invention addresses that need while avoiding the shortcomings and drawbacks of conventional attempts.

### SUMMARY OF THE INVENTION

In general terms, this invention is an elevator door assembly having a door mover and an interlock positioned near a lower edge of the door.

One elevator car assembly designed according to this invention includes a frame. At least one cabin door is supported for guided movement relative to the frame. A door mover moves the door between open and closed positions. The door mover is supported by the frame near a lower edge of the door. An interlock that provides for simultaneous movement of a corresponding hoistway entrance door with the cabin door is also positioned near the lower edge of the door.

In one example, a sill member is located beneath the door with the door mover and the interlock are both supported beneath the sill.

In one example, the sill includes a groove through which a portion of the door extends. The door mover is coupled with the extending portion of the door such that the door mover is capable of moving the door as needed to provide access to the cabin.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates selected portions of an elevator car assembly incorporating a door mover and interlock arrangement desired according to an embodiment of this invention.

FIG. 2 is a side, partial cross sectional view showing selected portions of one example embodiment.

FIG. 3 is a front view schematically illustrating the embodiment of FIG. 2.

FIG. 4 is a front view schematically illustrating an alternative embodiment.

FIG. 5 is a side view schematically illustrating interaction between a cabin door and a hoistway door.

FIG. 6 is a front view of the hoistway side of the embodiment of FIG. 5.

### DETAILED DESCRIPTION OF THE PREFERRED EMBODIMENTS

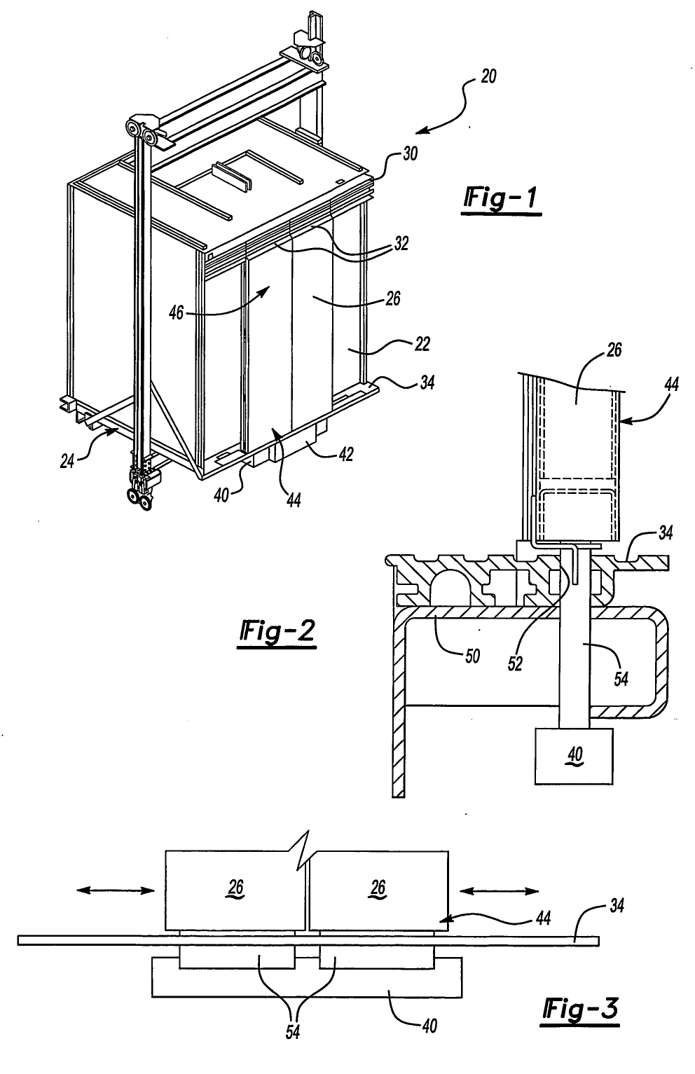

FIG. 1 schematically shows an elevator car assembly 20 where a cabin 22 is supported by a car frame 24 in a conventional manner. Two cabin doors 26 are selectively moveable between a closed position (as shown) and an open position to provide selective access to the interior of the cabin 22.

As known, the cabin doors 26 are supported on a rail 30 by hangers 32, which may include rollers, for example, for guiding movement of the doors 26 along the rail 30. A sill member 34 is supported by the frame near a bottom of the doors 26.

In this example, a door mover 40 (i.e., motor, gear box, controller, drive mechanism, etc.) is supported near an interlock device 42, which facilitates simultaneous movement of the cabin doors 26 and hoistway entrance doors (FIGS. 5 and 6). The door mover 40 and interlock 42 are supported near a lower edge 44 of the doors 26. Conventional arrangements had such components supported near an upper edge 46 of the doors 26. Placing the door mover 40 and the interlock 42 in the lower location shown in this embodiment provides significant advantages during elevator installation and alignment procedures and increases the overhead clearance of the car assembly.

The door mover 40 may include a variety of conventional components arranged to achieve the necessary door movement. Similarly, the interlock device 42 may include a variety of conventional components that facilitate moving hoistway doors with cabin doors as known. The door mover 40 and the interlock device 42 are schematically shown. Given this description, those skilled in the art will realize what particular door mover and interlock components will best meet the needs of their particular situation when implementing this invention.

FIG. 2 is a side view of selected portions of the door assembly. The sill member 34 is supported by a frame portion 50. The sill member 34 in this example includes a slot 52 through which an extending portion 54 of the door 26 is received. The door mover 40 has an appropriate coupling with the extending portion 54 of the door 26 such that the operative components of the door mover are capable of moving the door 26 as required to move the doors between open and closed positions. In this example, a portion of the door 54 extends through the slot 52 in the sill member 34 such that the door mover 40 can operate within the same plane as that in which the door 26 lies.

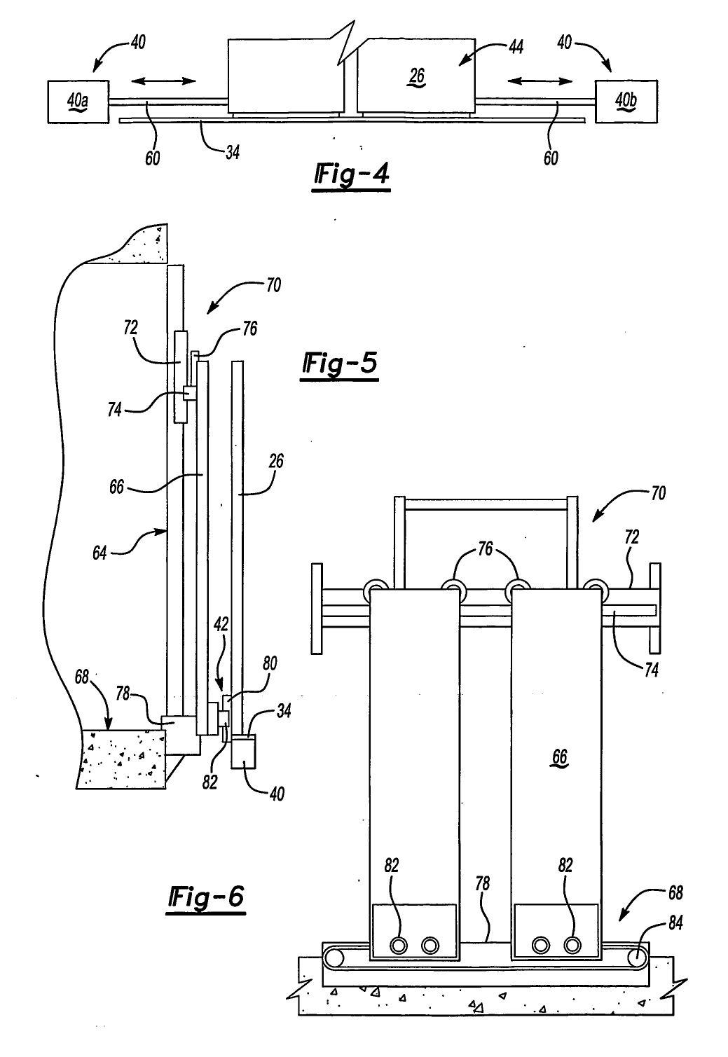

Another example arrangement is shown in FIG. 4 where the door mover 40 has separate portions 40A and 40B associated with corresponding ones of the cabin doors 26. In this example, linking members 60, which may comprise mechanical linkages or chains, for example, provide a connection between the doors 26 and the door mover 40 to allow for the desired movement of the doors. Other arrangements are within the scope of this invention.

The embodiments shown in FIGS. 1 through 3 have the door mover 40 completely beneath the bottom edge of the doors 26. In the example of FIGS. 2 and 3, the door mover components 40 are all beneath the sill member 34. In the example of FIG. 4, at least some of the door mover components are above the sill 34 but close to the lower edge 44 of the doors 26. In either example, the advantage of having the door mover located near the lower edge of the cabin doors is realized.

The interlock device 42 has not been shown in FIGS. 2-4 for purposes of discussing the mover 40. Referring to FIGS. 5 and 6, an example interlock arrangement is schematically shown. In this example, the car doors 26 selectively close off the cabin 22 while the hoistway entrance openings 64 are selectively closed off by hoistway entrance doors 66. The interlock device 42 provides for simultaneous movement of the doors 26 and the doors 66 when the car is appropriately aligned with a selected landing 68.

In this example, a door frame assembly 70 includes a header portion 72. A rail 74 is supported as part of the header portion 72 such that rollers 76 allow for guided movement of the doors 66 along the rail 74. A sill member 78 is positioned near a lower edge of the hoistway doors.

The illustrated example of an interlock device 42 includes at least one vane 80 that extends away from a surface of the cabin door 26. At least one set of rollers 82 is selectively engaged by the vane 80 to provide for simultaneous movement of the cabin doors 26 and the hoistway doors 66 in a generally known manner. In the inventive arrangement, the door interlock device 42 is supported near the lower edge 44 of the cabin doors 26. In the example of FIG. 1, the interlock device 42 is beneath the bottom edge of the doors and beneath the sill member 34. In the example of FIGS. 5 and 6, the interlock device 42 is supported near the lower edge of the doors without being entirely beneath the doors or beneath the sill member 34. Given this description, those skilled in the art will be able to select from among common interlock components and be able to locate them in accordance with the teachings of this description to meet the needs of their particular situation.

Placing the door mover 40 and the interlock 42 near the lower edge of the doors minimizes any distance between those components and sill-related alignment of the doors. The inventive arrangement therefore facilitates faster, easier and more accurate installation.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator car assembly (20), comprising
a frame (24);
at least one cabin door (26) supported for guided movement relative to the frame (24);
a door mover (40) for moving the door between open and closed positions, the door mover being supported by the frame near a lower edge (44) of the door; and
an interlock (42) for simultaneously moving a corresponding hoistway entrance door (66) with the cabin door (26), the interlock (42) being positioned near the lower edge (44) of the door.

2. The assembly of claim 1, including a sill member (34) beneath the door (26) and wherein the door mover (40) and the interlock (42) are supported beneath the sill.

3. The assembly of claim 2, wherein the sill member (34) is located beneath the door (26) and supported by the frame (50) at least partially in a plane containing the door (26).

4. The assembly of claim 3, wherein the sill member (34) includes a groove (52) that receives a portion (54) of the door to guide movement of the lower portion of the door as the door moves between the open and closed positions.

5. The assembly of claim 4, wherein the portion (54) of the door extends through the groove (52) in the sill member and the mover is coupled with the extending door portion such that the mover selectively moves the door.

6. The assembly of claim 1, wherein the door mover (40) is supported beneath the door.

7. The assembly of claim 1, wherein the interlock (42) is supported beneath the door.

8. An elevator door assembly (20), comprising:
a car frame (24) having a rail (30) and a sill (34);
at least one car door (26) supported for movement along the rail (30) and the sill (34) between an open and a closed position;
a door mover (40) supported near a lower edge (44) of the car door;
an entrance door frame (70) having a header (72) and a sill (78) that are adapted to be supported in a fixed position near an opening to a hoistway;
at least one hoistway door (66) supported for movement relative to the header (72) and door frame sill (78) between open and closed positions; and
an interlock (42, 80, 82) that couples the car door (26) to the hoistway door (66) such that the doors move together responsive to the door mover (40), the interlock (42) being supported near the door mover.

9. The assembly of claim 8, including a sill member (34) beneath the car door (26) and wherein the car door mover (40) and the interlock (42) are supported beneath the sill (34).

10. The assembly of claim 9, wherein the sill member (34) is located beneath the car door (26) and supported by the car frame (50) at least partially in a plane containing the car door.

11. The assembly of claim 10, wherein the sill member (34) includes a groove (52) that receives a portion (54) of the car door to guide movement of the lower portion of the car door as the car door moves between the open and closed positions.

12. The assembly of claim 11, wherein the portion (54) of the car door extends through the groove (52) in the sill member (34) and the mover (40) is coupled with the extending car door portion (54) such that the mover (40) selectively moves the car door.

13. The assembly of claim 8, wherein the car door mover (40) is supported beneath the car door (26).

14. The assembly of claim 8, wherein the interlock (42) is supported beneath the car door (26).
